(19) United States
(12) Patent Application Publication
(10) Pub. No.: US 2009/0265132 A1
(43) Pub. Date: Oct. 22, 2009

(54) DEVICE AND METHOD FOR DETERMINING THE DENSITY OF A FLUID

(75) Inventors: Wolfgang Schrittenlacher, Hamburg (DE); Christian Maurer, Hamburg (DE); Stefan Kunter, Hamburg (DE)

Correspondence Address: HOVEY WILLIAMS LLP, 10801 Mastin Blvd., Suite 1000, Overland Park, KS, 66210, US

(73) Assignee: Fafnir GmbH, Hamburg (DE)

(21) Appl. No.: 12/106,069

(22) Filed: Apr. 18, 2008

(51) Int. Cl. G01N 9/36; G01F 23/30

(52) U.S. Cl. 702/137; 73/453; 73/314

(57) ABSTRACT

A device for determining the density of a fluid comprises a buoyant body, a spring which engages on the buoyant body and whose elastic deformation is a measure of the buoyancy force of the buoyant body, and a magnet which is designed to sense the elastic deformation of the spring by means of a magnetostrictive position-measuring system. The spring is compressively loaded and, if the buoyancy force of the buoyant body is greater than its weight, said spring acts on the buoyant body underneath its centre of buoyancy. The device is preferably used to determine the density of fuel, a magnetostrictive filling level measuring system which is present in a storage tank for fuel being used.

### CROSS REFERENCE TO APPLICATION

German Application Serial No. 10 2006 033 237.7, filed Jul. 18, 2006 and European Application Serial No. 07008114.6, filed Apr. 20, 2007 are hereby incorporated in their entirety by reference herein.

### BACKGROUND

1. Field

The invention relates to a device and a method for determining the density of a fluid, in particular for determining the density of fuel in a storage tank, for example at a fuel filling station, in a tank farm or in a tanker motor vehicle. The density which is measured and determined in this way can be used in data management at fuel filling stations and for quality assurance. This is because the density of fluids is an important indicator for the determination of their quality.

2. Discussion of Prior Art

In a conventional method for determining the density of a fluid, use is made of a differential pressure sensor which is arranged in the region of the fluid and in which the density can be determined directly from the measured pressure difference and the known level of the fluid. Differential pressure sensors with the necessary accuracy in the per mill range are, however, very complex and expensive, in particular if they are to be used in explosion-protected areas, such as is necessary, for example, for a fuel filling station.

Another possibility are indirect methods such as the determination of the density from the optical density n or the dielectric constant. This is however inaccurate and unreliable.

A further method, which is also complex, is to determine the mass of a known volume of fluid from the oscillation of a resonator such as is utilized, for example, in the determination of density by Coriolis flow sensors.

It has already been known for a long time to measure the density of a fluid using float-type areometers. Since an areometer does not become completely immersed in the fluid, it migrates with the filling level of the fluid in a reservoir container, which is not suitable for continuous measurement with changing levels or filling levels.

U.S. Pat. No. 5,942,684 discloses a method in which the density can be determined by means of the displacement of a buoyant body which operates counter to an elastic element. In this context, the buoyancy force is measured by means of a strain gauge.

A similar possibility is described in U.S. Pat. No. 6,418,788. In this context, a buoyant body is displaced in an arrangement with two helical springs, and the displacement is determined using a Hall effect sensor.

U.S. Pat. No. 5,471,873 and U.S. Pat. No. 5,253,522 disclose how a density-measuring means can be integrated into a filling level measuring system which is already present. In this context, one helical spring is provided above a buoyant body and another is provided below it so that the buoyant body is displaced counter to the spring forces depending on the level of the buoyancy force, that is to say depending on the magnitude of the density of the fluid in which the buoyant body is located. This displacement is determined with a high degree of accuracy using magnetostrictive position measurement. The magnetostrictive position measurement is a known technique (see for example U.S. Pat. No. 3,189,849 and U.S. Pat. No. 3,225,312) and is used in mechanical engineering and in filling level measuring technology because of its advantages for position-measuring tasks.

In many storage tanks fluids are stored and, depending on the application, for example for the billing mode, the volume or the mass of the stored fluid has to be known. While the volume can be determined using the filling level by means of what is referred to as a dipping table, the mass can be identified from the volume and the density.

In storage tanks in which the filling level is determined by means of a magnetostrictive position-measuring system, there are generally only small feedthroughs available, for example feedthroughs with a diameter of ½ inches, for the installation of a measuring probe. This restriction also applies to a density-measuring system with a buoyant body, such as is described in U.S. Pat. No. 5,471,873 and U.S. Pat. No. 5,253,522. In order to be able to measure the density accurately, there is, however, a need for the largest possible buoyant body and/or a soft spring so that a predefined difference in the buoyancy force results in the greatest possible change in the length of the spring. However, in the abovementioned, previously known systems according to U.S. Pat. No. 5,471,873, U.S. Pat. No. 5,253,522 and U.S. Pat. No. 6,418,788, in each case two springs are provided for guiding a buoyant body. As a result, the usable measuring travel halves for a predefined spring constant. Since, in addition, in the case of density measurement using a buoyant body which operates counter to an elastic element, a state of equilibrium is reached between the buoyancy force, the force of gravity and the spring force, even small friction effects lead to hysteresis and to falsification of the measured values. Furthermore, with the previously known arrangements a tilting moment is produced in the buoyant body even as a result of very small imbalances, and this leads to increased friction.

### SUMMARY OF THE INVENTION

The object of the invention is therefore to improve the density-measuring devices which are previously known in particular from U.S. Pat. No. 5,471,873 and U.S. Pat. No. 5,253,522 and to provide a possible way of determining the density of a fluid in conjunction with a magnetostrictive position-measuring system with relatively little complexity and with a high degree of precision.

This object is achieved by means of a device for determining the density of a fluid having the features of claim 1 and a method for determining the density of a fluid having the features of claim 10. Advantageous refinements of the invention emerge from the subclaims.

The device according to the invention for determining the density of a fluid has a buoyant body, a spring which acts on the buoyant body and whose elastic deformation is a measure of the buoyancy force of the buoyant body, and a magnet which is designed to sense the elastic deformation of the spring by means of a magnetostrictive position-measuring system. The magnetostrictive position-measuring system can be a component of the device, but it can also be an external component which is provided, for example, in a storage tank for fuel in a fuel level measuring system.

According to the invention, the spring is subjected to compression loading. It acts on the buoyant body below the centre of buoyancy of the buoyant body if the buoyancy force of the buoyant body is greater than its weight. If, on the other hand, the buoyancy force of the buoyant body is smaller than its weight, the spring acts on the buoyant body above the centre of buoyancy of the buoyant body. The centre of buoyancy is defined here as the centre of mass of the buoyant body which would be present given homogeneous density distribution of the buoyant body. Or in other words the centre of buoyancy is the centre of mass of the expelled fluid if it assumes the shape of the buoyant body.

The buoyancy force of the buoyant body is the same as the weight of the fluid which is expelled by the buoyant body, that is to say is equal to the product of the volume of the buoyant body and the density (or the specific weight) of the fluid. Depending on the size of the buoyancy force, the spring is deformed to a greater or lesser degree. If the magnet moves along when the spring experiences deformation, it changes its position, which can be sensed by the magnetostrictive position-measuring system. The spring is subject to compression loading, so that, for example, a spring which is configured as a helical spring can act directly on the buoyant body or on a counter bearing. In contrast, in the event of a tensile spring, complex connections which are capable of picking up tensile forces and which take up space are necessary. Depending on the configuration of the buoyant body, the buoyancy force of the buoyant body which is to be expected for a given fluid is greater or smaller than the weight of the buoyant body. In both these cases, the spring acts on different locations of the buoyant body with respect to the centre of buoyancy. As a result, a stable position of the buoyant body in the fluid is achieved. In addition, as a result, the friction, for example with respect to a guide tube, can be kept very low so that the buoyant body can follow changes in density in the fluid virtually without hysteresis. This advantageous effect is even enhanced if the centre of mass of the buoyant body is below the centre of buoyancy of the buoyant body.

The spring provided is preferably a spring which is configured precisely as a helical spring. A plurality of springs are also conceivable, for example a spring device with a number of leaf springs which are arranged on a cylinder casing and are oriented parallel to the longitudinal axis of this cylinder. In its method of operation, the last-mentioned device is comparable to a helical spring.

The buoyant body preferably has a cut-out along its longitudinal axis in which the spring is (at least partially) arranged. In this way, the spring can be positioned easily and in a way which is economical in terms of space such that it acts on the buoyant body in the way described above.

In one preferred embodiment of the invention, there is, apart from the already mentioned magnet, a secured reference magnet provided, the difference between the position of the magnet and that of the reference magnet along a measuring wire of the magnetostrictive position-measuring system being a measure of the elastic deformation of the spring to be determined. This makes it possible to construct the device according to the invention as a unit and to use it, for example, in conjunction with a filling level measuring system which is already present in a storage tank. If the magnet is located, for example, in the buoyant body so that it also experiences the movement of the buoyant body and the reference magnet is, in contrast, located on a fixed counter bearing of the spring, the deformation of the spring results from the difference between the position of the magnet and that of the reference magnet irrespective of the level at which the device is mounted on the magnetostrictive filling level measuring system. If, in contrast, there is only one magnet present which also experiences the movement or deformation of the spring, the setting of the device depends on the absolute level at the magnetostrictive position-measuring system and can be moved, for example for maintenance work.

The buoyant body preferably has a cut-out for holding a guide tube. This cut-out can be identical to the abovementioned cut-out for the spring. The guide tube can preferably be moved via a protective tube for the measuring wire of a magnetostrictive position-measuring system.

Basically, the device according to the invention and the method which is carried out with it for determining the density of a fluid can be used with virtually any fluids. However, the invention is particularly advantageous if it is used to determine the density of fuel. In this case, a magnetostrictive position-measuring system which is present in any case in a storage tank for fuel and which is used as a filling level measuring system is preferably provided as the magnetostrictive position-measuring system.

Such filling level measuring systems are widespread. They contain a preferably vertically oriented measuring wire in a protective tube which is connected to measuring electronics. The protective tube serves at the same time to guide a float in which a magnet is mounted and which floats on the surface of the fuel. The position of this magnet, that is to say the filling level, can be identified using the magnetostrictive effect. Since the measuring electronics are capable of processing the measurement signals with respect to a plurality of magnets which are positioned at different levels, magnetostrictive position-measuring systems in a storage tank for fuel are frequently provided with a second float which floats in the lower region of the storage tank at a boundary between water and the specifically lighter fuel. In this way it is possible to register the water content in the storage tank. A magnetostrictive position-measuring system which is frequently already present in a storage tank and which has associated measuring electronics is therefore able to determine the positions of a plurality of magnets and can therefore be retrofitted with comparatively little expenditure (essentially programming expenditure) in such a way that the positions of the magnet and, if appropriate, of the reference magnet of the device according to the invention can additionally be measured in order to determine the density.

In particular storage tanks at a fuel filling station or in a tank farm are possible as the storage tank for fuel. The density of the fuel can, however, also be determined in a payload tank of a tanker motor vehicle in the way explained.

In one advantageous embodiment of the invention, a plurality of buoyant bodies with assigned springs and magnets are arranged at different levels of the magnetostrictive position-measuring system of a storage tank. This makes it possible to determine the density of the fuel at different levels. As already explained, a magnetostrictive position-measuring system is basically able to differentiate the positions or heights of a plurality of magnets.

The computing operations which are necessary for the determination of the density can be carried out on a computer which is present in the region of a fuel filling station. The calculation includes the known volume of the buoyant body which dips completely into the fluid, the known weight of the buoyant body, the properties of the spring which are identified by previous standardization measurements and the measured position of the magnet (or the difference between the measured position of the magnet and that of the reference magnet), in a way which is comprehensible to a person skilled in the art.

In additional steps to the method for determining the density, the density which is identified or determined in the way described can be used for a plurality of applications.

A large field of application for this is data management and quality assurance at a fuel filling station. The measured or determined density value for the fuel in a storage tank can therefore be multiplied by the volume of the fuel in the storage tank which is identified by using filling level measurement in order to calculate the mass of the fuel in the storage tank. This may be appropriate for billing purposes.

In addition, the density of the fuel (or more generally of a fluid) is a measure of the composition and/or quality of the fluid so that the determined density can be used to identify the composition or quality of the fuel.

Additional possibilities are obtained if an alarm and/or an emergency deactivation system is triggered if the density which is determined using the device according to the invention or the method according to the invention is outside a predefined range. An example is the differentiation of fuel and water through a density measurement, in which case, if appropriate, an alarm is triggered if the density measurement indicates the presence of the wrong fluid.

In addition, the values for the density which are measured in the course of time can be recorded in order to log the density profile, for example in a storage tank for fuel. In this context it may be appropriate additionally to measure the temperature of the fluid or of the fuel and to record the measured temperature values together with the assigned density values. It is therefore possible, for example, to determine temperature-compensated density values. Such recording and documentation of the density permits quality trends to be checked.

Numerous application possibilities are therefore obtained for quality assurance and data management, for example in the field of fuel tank filling stations, in tanker vehicles or in a tank farm, and also for other fluids which are not fuels.

Other aspects and advantages of the present invention will be apparent from the following detailed description of the preferred embodiments and the accompanying drawing figures.

### BRIEF DESCRIPTION OF THE DRAWING FIGURES

The invention will be explained in more detail below using exemplary embodiments. In the drawings,

FIG. 1 is a side view of a magnetostrictive filling level and separating layer measuring system which is equipped with an embodiment of the device according to the invention for determining the density of a fluid,

FIG. 2 is a longitudinal section through the device for determining the density of a fluid according to FIG. 1,

FIG. 3 is a fragmentary cross-sectional view of the magnetostrictive measuring system shown in FIGS. 1 and 2, showing a measuring wire of the system extending through a protective tube,

FIG. 4 is a fragmentary cross-sectional view of a magnetostrictive measuring system constructed in accordance with a second preferred embodiment of the present invention, and

FIG. 5 is a side view of a magnetostrictive measuring system constructed in accordance with a third preferred embodiment of the present invention, showing a plurality of buoyant bodies.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

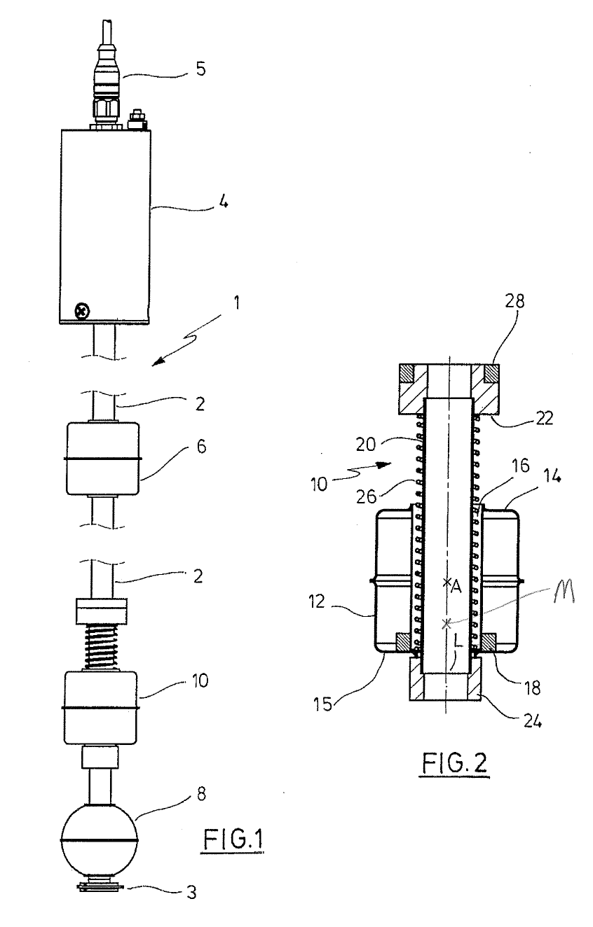

FIG. 1 firstly illustrates a conventional filling level and separating layer measuring system 1 which is provided with a magnetostrictive position-measuring system and can be installed, for example, in a storage tank for fuel.

The filling level and separating layer measuring system 1 has a protective tube 2 which extends as far as an end widened portion 3 at its lower end. In the installed state, the end widened portion 3 is located just before the lowest point of a storage tank.

In the interior of the protective tube 2, a measuring wire W of a magnetostrictive position-measuring system which leads to an electronic unit 4 extends on its longitudinal axis. The electronic unit 4 contains, at its upper side, a connection 5 for connecting a signal cable which can be connected to an external evaluation and control device.

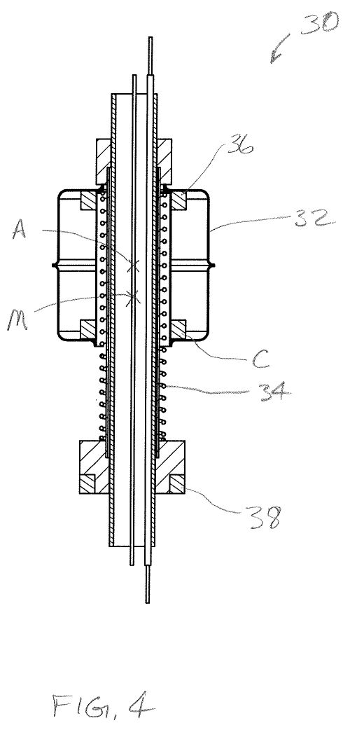

Magnetostrictive measuring systems are known, as mentioned at the beginning. In this context, a permanent magnet is used as a position signal transmitter. As a result of the magnetostrictive effect, ultrasonic sound waves are generated in a magnetostrictive wave guide, here the measuring wire W (see FIG. 3) which is contained in the protective tube 2. The propagation time of these ultrasonic sound waves can be measured with a high degree of precision, for which purpose the electronic unit 4 is used here so that the position of the permanent magnet can be determined reproducibly up to, for example, an accuracy of 10 μm. It is also possible to measure simultaneously or virtually simultaneously a relatively large number of such magnetic position signal transmitters on a magnetostrictive wave guide, which is already utilized in the filling level and separating layer measuring system in its conventional embodiment.

For this purpose a filling level float 6 is guided on the protective tube 2 and it floats on the surface of the fluid which is located in the storage tank. In the interior of the filling level float 6 there is a permanent magnet which can be used to determine the position of the filling level float 6, that is to say the filling level in the storage tank, by means of the magnetostriction effect.

In the lower region of the filling level and separating layer measuring system 1 a separating layer float 8 is arranged, which can be moved, like the filling level float 6, along the protective tube 2 which serves for guidance purposes and also contains a permanent magnet. The separating layer float 8 is matched to a different density range and in the exemplary embodiment it floats at a boundary between water and the specifically lighter fuel. For this reason, the separating layer float makes it possible to determine the level of water which can collect below the fuel in a storage tank for fuel in the course of time.

In order to be able to measure the density of the fuel in the storage tank, the filling level and separating layer measuring system 1 is provided with an additional component, specifically a density-determining device 10.

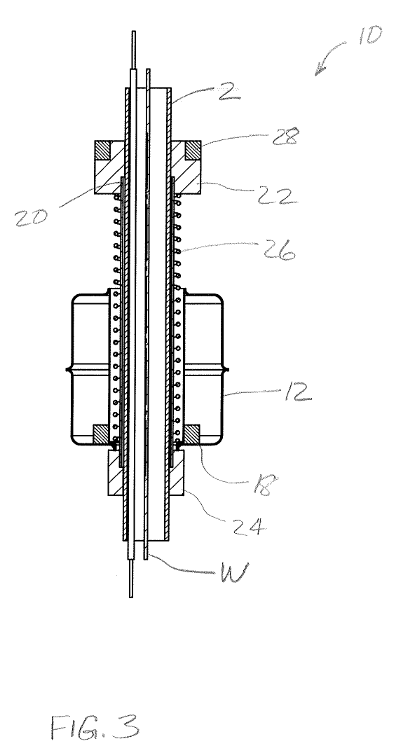

The density-determining device 10 is illustrated in an enlarged longitudinal section in FIGS. 2 and 3.

A buoyant body 12 with an upper end 14 and a lower end 15, which is of rotationally symmetrical design about its longitudinal axis L in the exemplary embodiment, has a cylindrical cut-out 16 along the longitudinal axis L. In the vicinity of its lower end 15, the interior of the buoyant body 12 contains a magnet 18 which is a permanent magnet and serves as a position signal transmitter in the magnetostrictive position-measuring system.

The buoyant body 12 is mounted in a longitudinal displaceable fashion on a guide tube 20 which extends between an upper stop 22 and a lower stop 24. The internal diameter of the guide tube 20 is slightly larger than the external diameter of the protective tube 2.

In the region of its lower end 15, the buoyant body 12 has an opening whose diameter is slightly larger than the external diameter of the guide tube 20 but smaller than the internal diameter of the cylindrical cut-out 16 in the exemplary embodiment. As a result a projection is formed on which a helical spring 26 can be supported by its lower end. The upper end of the helical spring 26 bears against the upper stop 22.

The upper stop 22 contains a reference magnet 28.

Since the buoyant body 12 is of largely symmetrical design in the exemplary embodiment, its centre A of buoyancy is located approximately in the centre. As explained, the helical spring 26 acts, in the vicinity of the lower end 15, on the buoyant body 12, that is to say below the centre A of buoyancy. Since the magnet 18 is installed in the lower region of the buoyant body 12, the centre of mass M of the buoyant body 12 is also located below the centre A of buoyancy.

In the exemplary embodiment, the buoyancy force of the buoyant body 12 is greater than its weight when it is completely immersed in the fuel in the storage tank. For this reason, the buoyant body 12 moves upwards away from the lower stop 24, but it is prevented from making a further upward movement by the helical spring 26 which is compressed here. A state of equilibrium is therefore established between the buoyancy force on the one hand and the force of gravity or the spring force on the other. The greater the density of the fuel (to be more precise the greater its specific weight), the greater the buoyancy force, i.e. the greater the extent to which the helical spring 26 is compressed. The equilibrium position of the buoyant body 12 can be identified using the magnetostrictive position-measuring system by means of the magnet 18 which serves as a position signal transmitter.

The density-determining device 10 can be pushed over the protective tube 2 and secured to it using an adjusting screw. The adjusting screw is located in the upper stop 22, but is not illustrated in FIG. 2.

The reference magnet 28 can also be used as a position signal transmitter in the magnetostrictive position-measuring system. For this reason, the density-determining device 10 can be used without having to carry out standardization measurements for the absolute height of the magnet 18. The elastic deformation of the spring 26, which is a measure of the density of the fuel owing to the explained equilibrium, results from the difference between the position of the magnet 18 and that of the reference magnet 28.

Since the helical spring 26 acts on the buoyant body 12 below the centre A of buoyancy and because the centre of mass M of the buoyant body 12 is below the centre A of buoyancy, the buoyant body 12 automatically rights itself to a virtually vertical position. If the protective tube 2 is adjusted to a vertical position, virtually no disruptive friction forces therefore occur during the movement of the buoyant body 12. The explained equilibrium is thus not influenced by unknown forces.

If the helical spring 26 is a soft spring, its elastic deformation already changes when small forces are exerted, i.e. the density-determining device 10 becomes sensitive. In addition, a large overall length of the helical spring 26 gives rise to a high degree of sensitivity. Because of the arrangement of the helical spring 26 in the cut-out 16, a compact design of the density-determining device 10 can be achieved despite a relatively long spring length. This is advantageous since as a result of the arrangement of the density-determining device 10 on the filling level and separating level measuring system 1 the usable displacement for the filling level float 6 should not be restricted too much.

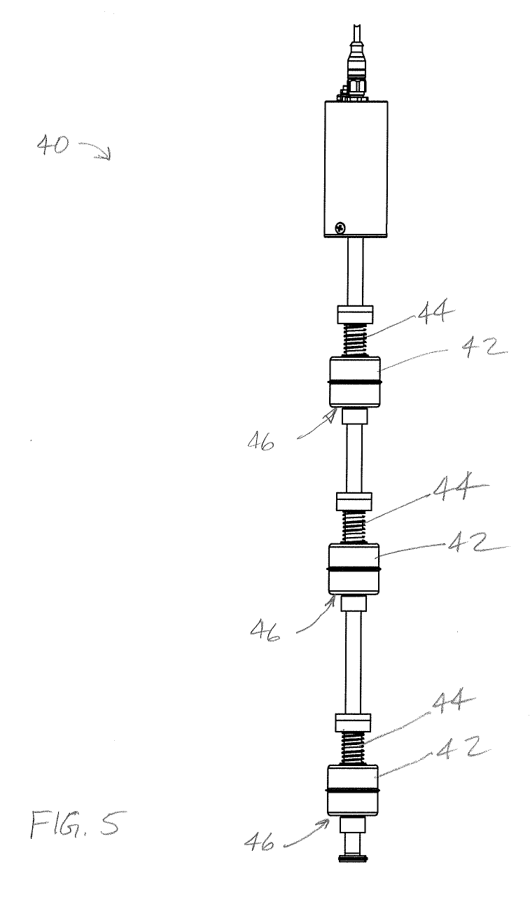

Turning to FIG. 4, an alternative density-determining device 30 is constructed in accordance with a second embodiment of the present invention. In the alternative density-determining device 30, the top and bottom are essentially interchanged compared to the exemplary embodiment according to FIGS. 2 and 3. Furthermore, a buoyant body 32 is heavier so that it would not rise upward without support. However, the helical spring 34 presses from below so that an equilibrium of the explained type is established again, with the position of the magnet 36 (or the difference between the position of the magnet 36 and that of the reference magnet 38) being a measure of the density which is to be determined.

In the second embodiment, the buoyant body 32 must therefore also be able to move, and the spring 34 acts on the buoyant body 32 above the centre A of buoyancy. In addition, the magnet should be arranged in such a way that the centre of mass M of the buoyant body 32 is below the centre A of buoyancy of the buoyant body 32, as in the first exemplary embodiment. Counterweight C is spaced oppositely from magnet 36 and serves to position the centre of mass M.

Turning to FIG. 5, an alternative density-determining device 40 is constructed in accordance with a third embodiment of the present invention. In the illustrated embodiment, the device 40 includes a plurality of buoyant bodies 42, a plurality of springs 44, and a plurality of magnets 46. The buoyant bodies 42, with assigned springs 44 and magnets 46, are arranged at different levels of the magnetostrictive position-measuring system of a storage tank. As discussed previously, this makes it possible to determine the density of the fuel at different levels. In addition, embodiments relating to the application possibilities, in particular in the region of a fuel filling station, can also be found there.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A device for determining the density of a fluid, said device including a buoyant body that presents a weight and a centre of buoyancy, a spring which engages on the buoyant body and whose elastic deformation is a measure of a buoyancy force of the buoyant body, and a magnet which is designed to sense the elastic deformation of the spring using a magnetostrictive position-measuring system, the improvement comprising:
said spring being compressively loaded,
said buoyancy force of the buoyant body being greater than the weight,
said spring engaging the buoyant body underneath the centre of buoyancy.

2. The device according to claim 1,
said spring comprising a single helical spring.

3. The device according to claim 2,
said buoyant body presenting a longitudinal axis and a cut-out which runs along the longitudinal axis, with the spring being arranged in the cut-out.

4. The device according to claim 1,
said buoyant body presenting a centre of mass that lies below the centre of buoyancy of the buoyant body.

5. The device according to claim 1; and
a fixed reference magnet, with the difference between the position of the first-mentioned magnet and that of the reference magnet along the measuring wire of the magnetostrictive position-measuring system being a measure of elastic deformation of the spring.

6. The device according to claim 1; and
a guide tube,
said buoyant body presenting a cut-out for receiving the guide tube.

7. The device according to claim 1,
said device being designed to determine the density of fuel.

8. The device according to claim 7,
said magnetostrictive position-measuring system being provided in an apparatus selected from the group consisting of a filling level, separating layer measuring system, and a combination thereof, which is operable to be present in a storage tank for fuel.

9. The device according to claim 8; and
a plurality of buoyant bodies with assigned springs and magnets,
said buoyant bodies being arranged at different levels of the magnetostrictive position-measuring system.

10. A method for determining the density of a fluid comprising the steps of:
completely immersing the buoyant body of a device according to claim 1 in the fluid; and
determining the buoyancy force of the buoyant body by sensing the elastic deformation of the spring using a magnetostrictive position-measuring system.

11. The method according to claim 10; and
determining the density of fuel by using a magnetostrictive position-measuring system which is provided in an apparatus selected from the group consisting of a filling level, separating layer measuring system, and a combination thereof, which is present in a storage tank for fuel.

12. The method according to claim 11; and
determining the density at different levels of the storage tank using a plurality of buoyant bodies with assigned springs and magnets which are arranged at different levels of the magnetostrictive position-measuring system.

13. The method according to claim 11; and
performing computing operations which are necessary for the determination of the density on a computer which is present in the region of a fuel filling station.

14. The method according to claim 11; and
calculating the mass of the fuel from a known volume of the fuel and from the determined density of the fuel.

15. The method according to claim 10; and
assigning the determined density of the fluid to a predefined density range as a measure of a fluid property selected from the group consisting of the composition of the fluid, the quality of the fluid, and a combination thereof.

16. The method according to claim 10; and
triggering a device selected from the group consisting of an alarm, an emergency deactivation system, and a combination thereof if the determined density is outside a predefined range.

17. The method according to claim 10; and
recording values for the density which are determined in the course of time.

18. The method according to claim 10; and
measuring the temperature of the fluid.

19. The method according to claim 11; and
using said storage tank in an application selected from the group consisting of a fuel filling station, a tank farm, a payload tank of a tanker motor vehicle, and combinations thereof.

20. A device for determining the density of a fluid, said device including a buoyant body that presents a weight and a centre of buoyancy, a spring which engages on the buoyant body and whose elastic deformation is a measure of a buoyancy force of the buoyant body, and a magnet which is designed to sense the elastic deformation of the spring using a magnetostrictive position-measuring system, the improvement comprising:
said spring being compressively loaded,
said buoyancy force of the buoyant body being smaller than the weight,
said spring engaging the buoyant body above the centre of buoyancy.
